(19) United States
(12) Patent Application Publication
(10) Pub. No.: US 2016/0138754 A1
(43) Pub. Date: May 19, 2016

(54) MAGNETIC UNIVERSAL MOUNTING ASSEMBLY

(71) Applicant: Telomere Venture Capital Limited, Tortola (VG)

(72) Inventor: Yungin Li, Kowloon (HK)

(21) Appl. No.: 14/540,512

(22) Filed: Nov. 13, 2014

(51) Int. Cl. F16M 13/02

(52) U.S. Cl. CPC F16M 13/022

(57) ABSTRACT

A magnetic universal mounting assembly includes a socket component and a magnetic semi-spherical locator. The socket component includes a mounting plate, a protrusion body extended upwardly from the mounting plate, a spherical socket defined in the protrusion body, and a magnet located into the spherical socket. The magnetic semi-spherical locator is configured to be snugly and magnetically fitted into the spherical socket of the protrusion body of the socket component by magnetic force between the locator and magnet such that the locator is capable of rotating freely with respect to the spherical socket.

### FIELD OF THE INVENTION

The invention relates to a mounting device and more particularly, the invention relates to a magnetic universal mounting assembly for retaining a device such as an electronic personal device of small size onto a desired object such as wall and providing free orientation and rotation of the same device based on desire of the user.

### BACKGROUD OF THE INVENTION

Many devices for example personal digital assistant, tablet, smartphone and so on need to be located and held onto a supporting object such as wall, dashboard, windshield of car and the like with freedom of changing their orientation. Other device such as monitor camera is also required to be mounted with desirable orientation and be adjusted freely regarding its rotation angle.

Adjustment and holding of above devices are usually realized by use of amounting assembly. Prior art mounting assembly suffers from drawbacks such as complex construction and time consuming in installation of the mounting assembly.

### SUMMARY OF THE INVENTION

A major object of the invention is to overcome drawbacks aforementioned and provide magnetic universal mounting assembly which is simple in structure and quick in installation.

To obtain the above objects, a technical solution is proposed as follows.

A magnetic universal mounting assembly includes a socket component and a magnetic semi-spherical locator. The socket component includes a mounting plate, a protrusion body extended upwardly from the mounting plate, a spherical socket defined in said protrusion body, and a magnet located into the spherical socket. The magnetic semi-spherical locator is configured to be snugly and magnetically fitted into the spherical socket of the protrusion body of the socket component by magnetic force between the locator and magnet such that the locator is capable of rotating freely with respect to the spherical socket.

Compared to prior art mounting assembly in which a number of screws and corresponding tool are necessary for holding the assembly onto the wall, the assembly of the instant invention benefits easy and quick installation and simple construction.

### BRIEF DESCRIPTION OF THE DRAWINGS

FIG. 1 shows a perspective view of a magnetic universal mounting assembly according to one embodiment of the invention;

FIG. 2 shows an exploded perspective view of a magnetic universal mounting assembly according to one embodiment of the invention;

FIG. 3 shows an exploded perspective view of a magnetic universal mounting assembly according to one embodiment of the invention viewed from another angle;

FIG. 4 illustrates assembling process of the a magnetic universal mounting assembly according to one embodiment of the invention; and

FIG. 5 illustrates an assembled magnetic universal mounting assembly according to one embodiment of the invention.

### DETAILED DESCRIPTION OF THE INVENTION

The present invention is described in further detail in conjunction with various embodiments and accompanied drawings.

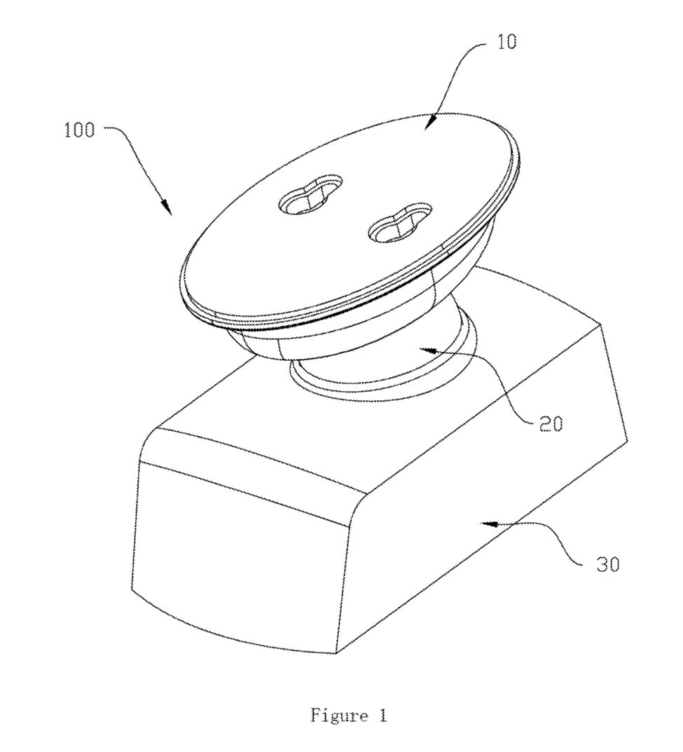

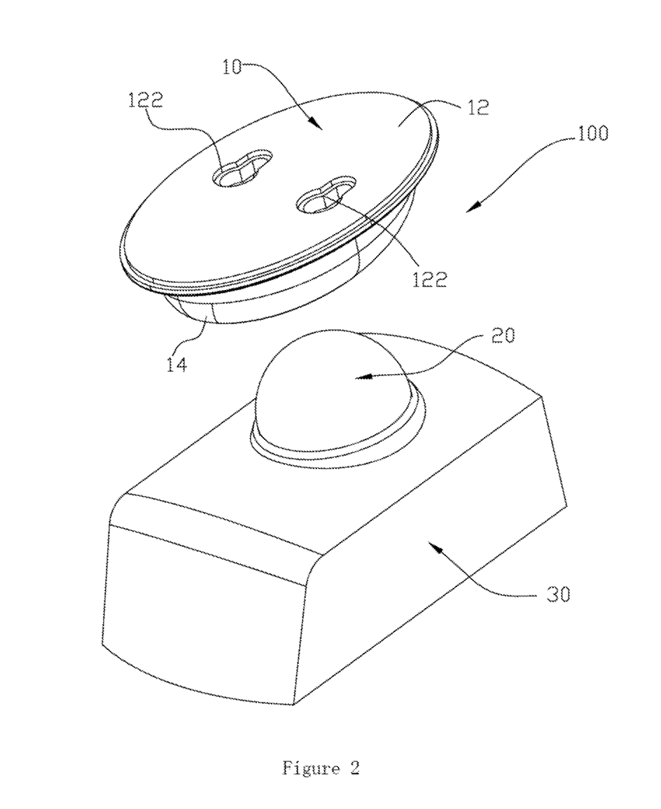

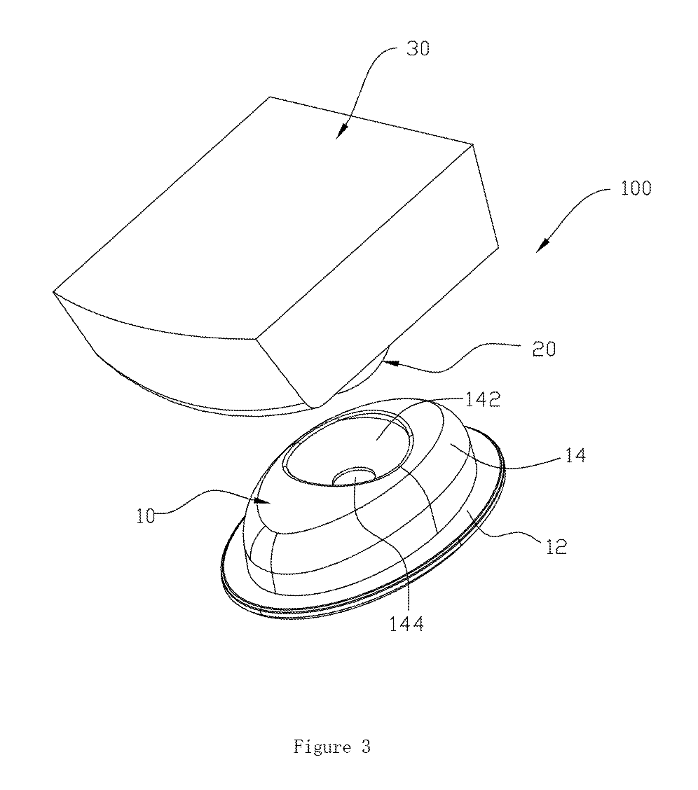

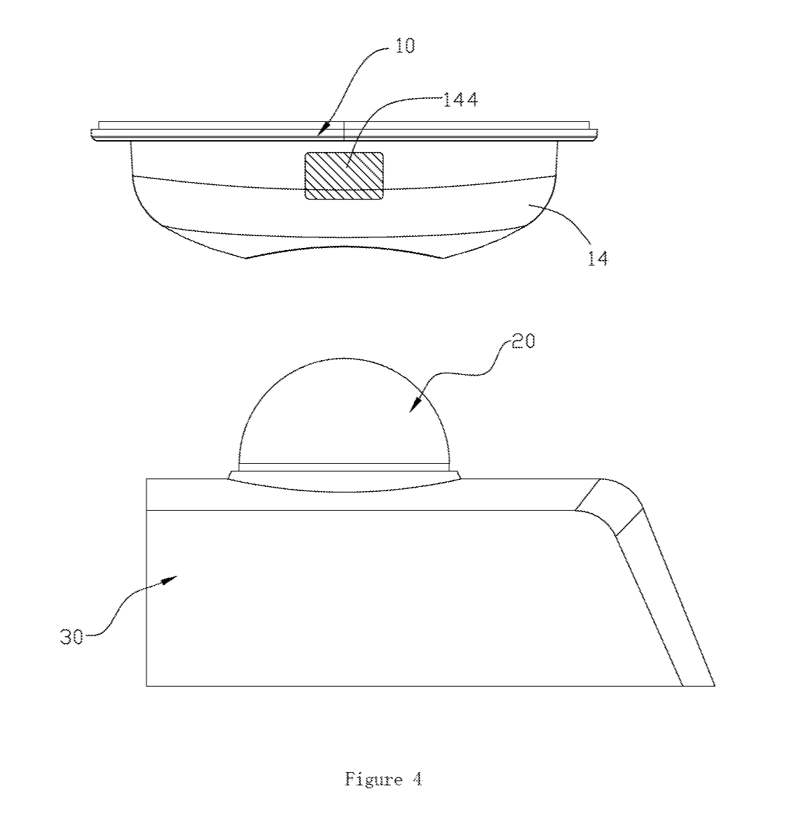

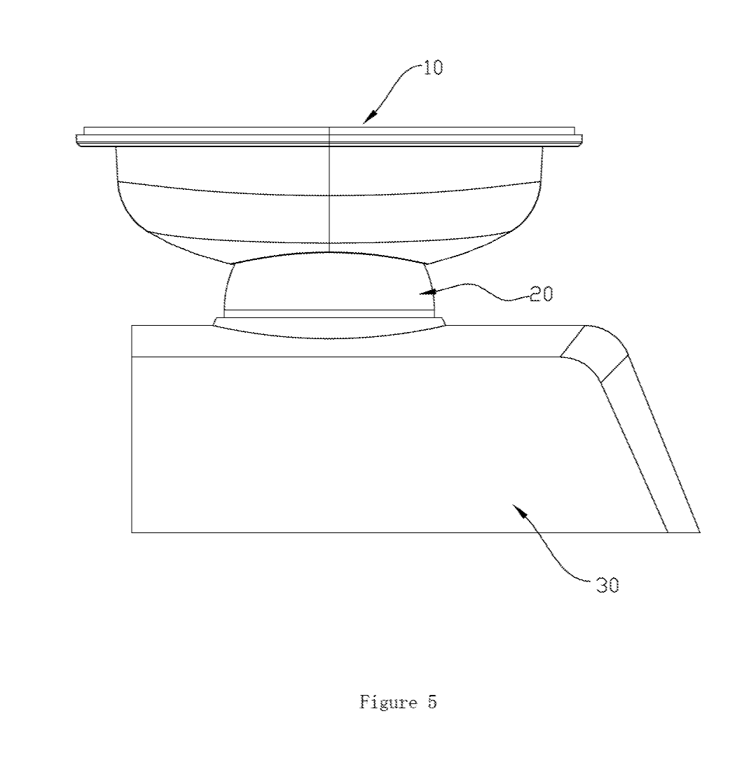

With reference to FIGS. 1-5, according to an embodiment of the present invention, magnetic universal mounting assembly 100 is provided.

The magnetic universal mounting assembly 100 includes a socket component 10 and a magnetic semi-spherical locator 20 for insertion into the socket component 10.

Said socket component 10 may be held onto other object such as a wall. By secure insertion of the locator 20 into the component 10, an electronic device such as a smartphone 30 provided thereon with said locator 20 may be pivotally mounted onto the component 10 and finally obtain free orientation and rotation of the same device relative to the wall. This will be described in greater detail in below paragraphs.

Said socket component 10 includes a mounting plate 12 e.g. of a circular or ellipse shape or any other suitable shape. This mounting plate 12 operates to hold the entire component 10 onto other object such as a wall. The component 10 also includes a protrusion body 14 extended upwardly from the mounting plate 12. A spherical socket 142 is defined in said protrusion body 14 into which a magnet 144 is located.

It is noted that the magnetic semi-spherical locator 20 of the invention may be snugly and magnetically fitted into the spherical socket 142 of the protrusion body 14 of the socket component 10. By magnetic force generated between the magnet 144 located into the spherical socket 142 and locator 20, the locator 20 is firmly held into the socket 142. In addition, due to semi-spherical ball shape of the locator 20 and spherical shape of the socket 142, the former is capable of rotating with respect to the latter and by this manner orientation and rotation angle of the locator is desirably adjusted.

When a device such as an electronic device or sensor is equipped with said locator 20 (for example by forming a clasping or locking mechanism on the device and clasping or locking the locator 20 onto the device), and when the socket component 10 is mounted onto a wall, the orientation and rotation of the device may be adjusted with free by a user by rotating the locator 20 with respect to the spherical socket 142. By this way, the device 30 can be mounted onto the wall indirectly through said magnetic universal mounting assembly.

Preferably, a number of mounting holes 122 may be defined in the mounting plate 12 on one side opposite to the protrusion body 14 for easily and conveniently hanging the entire socket component 10 onto a wall.

Compared to prior art mounting assembly in which a number of screws and corresponding tool are necessary for holding the assembly onto the wall, the assembly of the instant invention benefits easy and quick installation and simple construction (as no screw is used in the entire mounting process of the assembly).

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A magnetic universal mounting assembly comprising:
a socket component comprising a mounting plate, a protrusion body extended upwardly from the mounting plate, a spherical socket defined in said protrusion body, and a magnet located extending into the spherical socket; and
a magnetic semi-spherical locator configured to be snugly and magnetically fitted into the spherical socket of the protrusion body of the socket component by magnetic force between the locator and the magnet such that the locator is capable of rotating freely with respect to the spherical socket while being in spherical contact therewith.

2. The magnetic universal mounting assembly as recited in claim 1, further including a plurality of mounting holes provided in the mounting plate on one side opposite to the protrusion body for hanging the entire socket component onto a wall.
